(19) United States
(12) Patent Application Publication
(10) Pub. No.: US 2021/0276304 A1
(43) Pub. Date: Sep. 9, 2021

(54) LIQUID-PROOF STITCHED FABRIC AND STITCHING METHOD THEREFOR

(71) Applicants: Meihua WU, Quanzhou (CN); Wei GU, Dalian (CN)

(72) Inventors: Meihua WU, Quanzhou (CN); Wei GU, Dalian (CN)

(21) Appl. No.: 16/319,772

(22) PCT Filed: Aug. 9, 2016
(86) PCT No.: PCT/CN2016/094176

§ 371 Date: Jan. 22, 2019

(30) Foreign Application Priority Data
Aug. 3, 2016 (CN) 201610628898.6

(51) Int. Cl. B32B 7/14; B32B 5/02; B32B 27/12; B32B 27/32; B32B 27/30; B32B 27/36; B32B 27/34; B32B 37/06; B32B 37/12

(52) U.S. Cl. CPC B32B 7/14; B32B 5/022; B32B 27/12; B32B 27/32; B32B 27/306; B32B 27/304; B32B 2262/0253; B32B 27/34; B32B 37/06; B32B 37/1292; B32B 2307/7265; B32B 2262/0276; B32B 2262/0261; B32B 27/36

(57) ABSTRACT

A liquid-proof stitched fabric and a stitching method therefor. The liquid-proof stitched fabric comprises multiple liquid-proof fabric layer units stitched by means of a heat-sealing method, each of the liquid-proof fabric layer units comprises: at least one liquid-proof film layer, at least one thermoplastic non-woven fiber layer, and a discontinuous bonding layer located between the at least one liquid-proof film layer and the at least one thermoplastic non-woven fiber layer. The heat-sealing temperature of the heat-sealing method is lower than or equal to a complete melting temperature of the liquid-proof film layer, but is higher than a maximum start melting temperature of the thermoplastic non-woven fiber layer. By means of adopting a multicomponent liquid-proof film layer having two or more melting ranges, the range between the start melting temperature and the complete melting temperature can be broadened, and the stitching process can be widened.

### TECHNICAL FIELD

The present invention relates to a liquid-proof stitched fabric and a stitching method therefor, and in particular, relates to a method for stitching liquid-proof fabric seam in an overlapping manner by a heat-sealing technique.

### BACKGROUND OF THE INVENTION

At present, when liquid-proof fabrics are stitched, the barrier property thereof is prone to failure, and the seam is prone to cracking due to external forces, therefore, other stitching techniques have been adopted to ensure peeling strength and barrier property, but there exists some problems such as ineffective bonding, and that the liquid-proof layer tends to perforate and the barrier property can't be ensured, resulting in tremendous pressure to technology, market, cost and so on, and particularly, resulting in a great threat to the personal safety of product users.

CN102674270A discloses a heat-bondable laminated nonwoven fabric, but does not relate to a laminate of liquid-proof layers, and therefore, good peeling strength and vapor permeability are obtained, but a barrier effect can't be effectively achieved.

U.S. Pat. No. 7,390,376B2 discloses a heat-stitching method of fluid impervious laminates, but the stitching temperature is limited to below or equal to the melting point of the fluid impervious film layer, and when the thickness of the fluid impervious film layer becomes greater than 30 μm or the material manufacturer is changed, the sample cannot pass a barrier test of blood or virus, thus not meeting the market demand.

The fact that a seam of common liquid-impervious laminates is stitched but not impervious troubles the industry. The heat-stitching method only used for laminates of certain thickness can easily cause stiffness and instability at the stitching site, and the stitching conditions are too narrow, which brings enormous economic and social pressure to the cost of stitching and process stability, especially to the accuracy control, stability, and the safety of later application of equipment, and hinders the development of the market and the promotion of safe labor protection.

### Technical Problem

In view of the above-mentioned problems, the aim of the present invention is to provide a liquid-proof stitched fabric of smooth appearance without folds, and a stitching method therefor to make the seam have the characteristics of excellent peeling strength, liquid proofness, and a smooth appearance without wrinkles.

### Solution to the Problem

### Technical Solution

For that, in one aspect, the present invention provides a liquid-proof stitched fabric, the liquid-proof stitched fabric comprises a plurality of liquid-proof fabric layer units stitched by means of a heat-sealing method, and each of the liquid-proof fabric layer units comprises:

at least one liquid-proof film layer, the liquid-proof film layer comprising at least a first high melting range component and a second low melting range component, wherein a start melting temperature T1 of the first high melting range component is higher than a start melting temperature T2 of the second low melting range component by 10° C. or more;

at least one thermoplastic non-woven fiber layer, a maximum start melting temperature T3 of the thermoplastic non-woven fiber layer being lower than the start melting temperature T1 of the first high melting range component; and

a discontinuous bonding layer located between the at least one liquid-proof film layer and the at least one thermoplastic non-woven fiber layer;

wherein a heat-sealing temperature of the heat-sealing method is lower than or equal to a complete melting temperature T4 of the liquid-proof film layer, but higher than the maximum start melting temperature T3 of the thermoplastic non-woven fiber layer.

The liquid-proof film layer comprising multiple components with two or more melting ranges can widen the range between the start melting temperature and the complete melting temperature, and widen a stitching process. According to the present invention, sealing at a temperature higher than the maximum start melting temperature T3 of the thermoplastic non-woven fiber layer can achieve effective bonding, and the sealing temperature lower than or equal to the complete melting temperature of the high melting range component of the liquid-proof film layer can prevent perforation. If the stitching temperature is lower than the maximum start melting temperature T3 of the thermoplastic non-woven fiber layer, an effective bonding cannot be achieved. If the stitching temperature is higher than the complete melting temperature of the high melting range component of the liquid-proof film layer, the liquid-proof film tends to perforate and cannot maintain barrier property.

In the present invention, the thickness of the liquid-proof film layer may be 3 to 200 preferably 5 to 100 more preferably 5 to 50 Because the stitching processing conditions are widened due to the composition of the liquid-proof film, the barrier property of the seam of the liquid-proof stitched fabric provided herein will not be affected, even if the liquid-proof film layer is as thick as 30 μm or even 50 μm.

Preferably, the start melting temperature T1 of the first high melting range component is higher than the start melting temperature T2 of the second low melting range component by 15° C. or more, preferably 18° C. or more, which is beneficial to widening the stitching processing temperature.

In the present invention, the grammage of the thermoplastic non-woven fiber layer may be 1 to 500 gsm, preferably 5 gsm to 200 gsm, more preferably 20 gsm to 50 gsm, for increasing heat conductivity and strong support of the non-woven layer.

In the present invention, the grammage of the discontinuous bonding layer may be 0.8 to 50 g/m², preferably 0.8 to 16 g/m², more preferably 1 to 16 g/m². This makes it possible to increase the interlayer fastness, and prevent the product from being too heavy.

In the present invention, the first high melting range component and/or the second low melting range component may be at least one selected from polyolefin and its derivatives, polyvinyl acetate and its derivatives, polyvinyl chloride and its derivatives, polyvinyl alcohol and its derivatives, polyethylene terephthalate and its derivatives, polyamide and its derivatives, and polybutylene terephthalate and its derivatives.

In the present invention, the thermoplastic non-woven fiber layer may comprise at least one of: fiber of polyester and its derivatives, fiber of polyamide and its derivatives, fiber of polyolefin and its derivatives, bio-based fiber, and degradable fiber.

The present invention further provides a stitching method for a liquid-proof stitched fabric, the stitching method comprising:

dot gluing at least one liquid-proof film layer and at least one thermoplastic non-woven fiber layer with a glue, followed by cooling, rolling up, and glue curing, to form a liquid-proof fabric layer unit;

overlapping two adjacent liquid-proof fabric layer units, and heat sealing them at a heat-stitching temperature lower than or equal to the complete melting temperature T4 of the liquid-proof film layer, but higher than the maximum start melting temperature T3 of the thermoplastic non-woven fiber layer, to stitch the two adjacent liquid-proof fabric layer units together, wherein the heat sealing is conducted at a pressure of 0.01 to 1 MPa, preferably 0.1 to 0.8 MPa, for 0.01 to 600 seconds, preferably 1 to 60 seconds. Such heat sealing makes it possible to avoid a failure in liquid imperviousness due to excessive time or excessive pressure.

Preferably, the two adjacent liquid-proof fabric layer units are overlapped in such a manner that layers of the same material face each other. Thereby, surfaces to be heat sealed have the same material, thus can be better fused together.

In the present invention, the method for heat sealing may be ultrasonic heat sealing, radiofrequency heat sealing, pulse heat sealing, or roller heat sealing.

Preferably, the heat-sealing temperature is lower than or equal to the start melting temperature T1 of the first high melting range component, but higher than the maximum start melting temperature T3 of the thermoplastic non-woven fiber layer.

### THE BENEFICIAL EFFECT OF THE INVENTION BENEFICIAL EFFECT

The heat-sealing seam of liquid-proof fabrics stitched by the method of the present invention has the characteristics of excellent peeling strength, liquid imperviousness, and a smooth appearance without wrinkles. The liquid barrier test, especially a barrier test of hydrostatic pressure, blood, virus, and penetrative liquid, and performance of heat-sealing strength, are closely related to each layer's materials of the laminate, the amount of glue applied, and the condition of heat sealing.

### BRIEF DESCRIPTION OF THE DRAWINGS

### Drawings Description

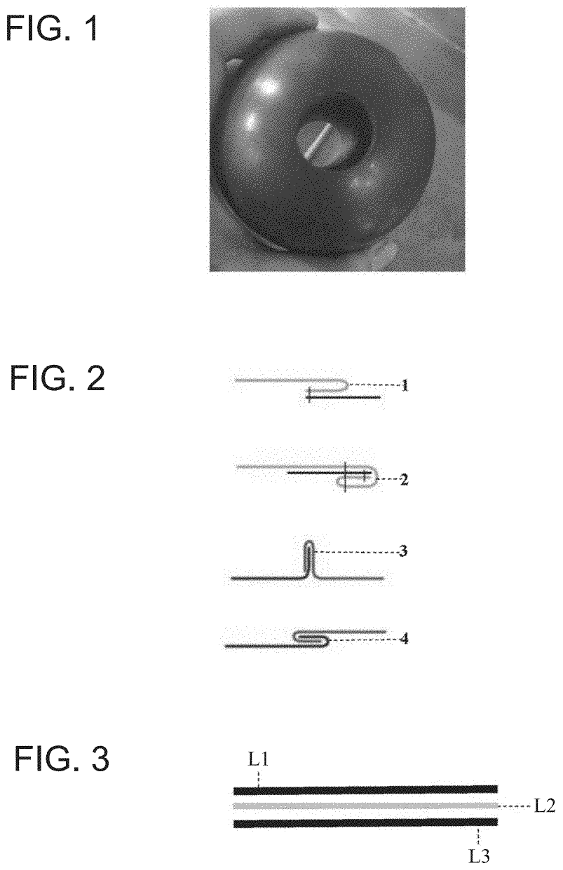

FIG. 1 shows a tool for crack resistance testing of the seam of the liquid-proof fabrics according to the present invention.

FIG. 2 is a schematic diagram showing overlapping of liquid-proof fabrics at the seam according to the present invention.

FIG. 3 shows a structural schematic diagram of the liquid-proof fabric according to the present invention.

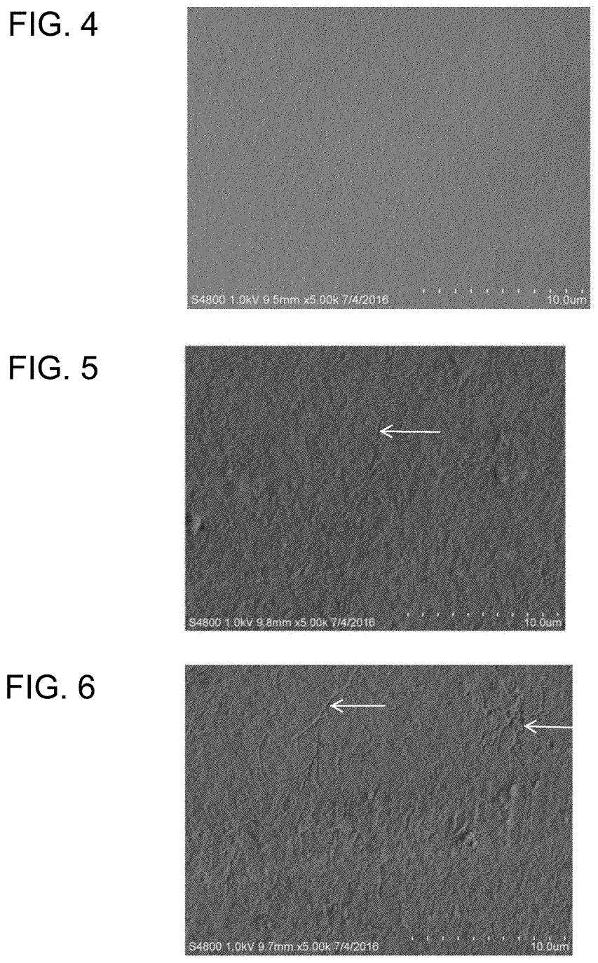

FIG. 4 shows a surface micrograph of the seam of the liquid-proof fabric obtained by example 1 of the present invention.

FIG. 5 shows a surface micrograph of the seam of the liquid-proof fabric obtained by example 3 of the present invention.

FIG. 6 shows a surface micrograph of the seam of the liquid-proof fabric obtained by example 11 of the present invention.

### THE PREFERRED EMBODIMENTS OF IMPLEMENTING THE INVENTION THE PREFERRED EMBODIMENTS OF THE PRESENT INVENTION

The present invention will be further described with the following embodiments with reference to the drawings. It should be understood that the drawings and the following embodiments are only used for explaining this invention, and do not limit this invention.

A heat-sealing method is employed to stitch liquid-proof fabrics in the present invention. The liquid-proof fabric is a laminate (layer unit) which has two or more layers. The structural schematic diagram of the liquid-proof fabric of the present disclosure is shown in FIG. 3, in which reference numbers “1”, “3” represent thermoplastic non-woven fiber layers, and reference number “2” represents a liquid-proof film layer. Each of the layer units may comprise: at least one multiple-component liquid-proof film layer with two or more melting ranges (comprising a first high melting range component and a second low melting range component), the difference between the start melting temperatures of each component being at least 10° C. (for example, a start melting temperature T1 of the first high melting range component being higher than a start melting temperature T2 of the second low melting range component by 10° C. or more), and at least one thermoplastic non-woven fiber layer in which at least one component comprises crystalline substances.

In the liquid-proof fabric, a maximum start melting temperature T3 of the thermoplastic non-woven fiber layer is lower than a complete melting temperature T4 of the multiple-component liquid-proof film layer, preferably lower than or equal to the start melting temperature T1 of the high melting range component of the liquid-proof film layer, more preferably lower than or equal to the start melting temperature of the low melting range component of the liquid-proof film layer.

In the liquid-proof fabric of the present disclosure, the grammage of the thermoplastic non-woven fiber layer may be 1 to 500 gsm, preferably 10 gsm to 200 gsm, more preferably 15 gsm to 50 gsm. The thickness of the liquid-proof film layer may be 3 to 200 preferably 4 to 100 more preferably 5 to 90 especially preferably 10 to 30 The grammage of the bonding layer is 0.8 to 50 g/m², preferably 0.8 to 16 g/m².

In the fabric of the present disclosure, the thermoplastic non-woven fiber layer may be a non-woven fabric of any material. Optionally, the material of the thermoplastic non-woven fiber layer is a mixture or copolymer of at least one of the following crystalline materials, for example, fiber of polyester and its derivatives, fiber of polyamide and its derivatives, fiber of polyolefin and its derivatives, bio-based fiber, degradable fiber and its derivatives, etc. The maximum start melting temperature T3 of any component of the thermoplastic non-woven fiber layer ranges from 60 to 300° C., preferably 60 to 230° C.

In the fabric of the present disclosure, the liquid-proof film layer is a continuous film layer, which can be formed by multi-layer co-extrusion or single-layer extrusion. The material of the liquid-proof film layer may be comprised of at least two polymers (or their derivatives or mixtures) selected from: polyolefin and its derivatives, polyvinyl acetate and its derivatives, polyvinyl chloride and its derivatives, polyvinyl alcohol and its derivatives, polyethylene terephthalate and its derivatives and mixtures, polyamide and its derivatives, and polybutylene terephthalate and its derivatives and mixtures.

In the fabric of the present disclosure, the liquid-proof film layer may be a multi-layer co-extrusion film of components with different melting ranges, or a blend film of components with different melting range. Preferably, the difference between the start melting temperatures of any two components is 15° C. or more, more preferably 18° C. or more. The maximum start melting temperature (the start melting temperature T1 of the first high melting range component) of the liquid-proof film layer is 80° C. or more, preferably 95° C. or more, more preferably 160° C. or more, and 350° C. or less.

The liquid-proof film layer can be formed by mechanically mixing raw materials, pre-blending, melting, granulation, followed by coating or extrusion. A preferable process can be selected according to formulations of the liquid-proof film layer. The film can be formed by single-layer preparation or multi-layer preparation, preferably by one to three-layer extrusion. A resin film of improved and controllable performance such as mechanical properties, dimensional stability, temperature range for use, liquid imperviousness can be obtained.

In the fabric of the present disclosure, a liquid-proof film layer and a non-woven fiber layer are dot glued with a glue, cooled and rolled up, then the glue is cured to form a liquid-proof fabric layer unit for subsequent stitching. The glue used can be a solvent glue, a water-based glue, a solvent-free glue or a coating material, preferably the solvent glue, the water-based glue, and the solvent-free glue. The solvent glue includes reactive and non-reactive glue, and preferably a wet-vapor reactive polyurethane glue, a two-component polyurethane glue, a siloxane pressure sensitive glue, a rubber pressure sensitive glue, a polyester pressure sensitive glue, a polyester solvent glue, a rubber solvent glue, etc. The water-based glue is preferably selected from a water-based acrylic glue, a polyurethane glue, an olefin hot-melting glue, a polyurethane hot-melting glue, a thermoplastic elastomer glue, a rubber, a polyester, a pressure sensitive glue, etc.

In the present disclosure, the device used for coating of liquid-proof fabric can be any gluing device, preferably a roll coating device, a spraying device, a slit coating device, etc.

Hereinafter, a method for stitching liquid-proof fabrics provided herein will be exemplarily described.

Two layers of liquid-proof fabric layer units are overlapped and subjected to heat stitching. The overlapping manner of the liquid-proof fabrics at the seam (as shown in FIG. 2) can be, but not limited to the manners as denoted by reference numbers “1”, “2”, “3”, “4” in FIG. 2. Attention should be paid to the flatness and length of seam position when overlapping, so as to facilitate the subsequent heat-sealing operation and ensure that the distance between the edge and the heat-sealing position is not more than 3 cm. The surfaces to be heat sealed can be any surfaces, preferably surfaces of the same material, for example, layer units can be overlapped in such a manner that a non-woven fiber layer of one layer unit and a non-woven fiber layer of another layer unit face each other, or a liquid-proof film layer of one layer unit and a liquid-proof film layer of another layer unit face each other. The heat-stitching (heat-sealing) temperature is higher than the melting temperature of the highest melting temperature component of the non-woven fiber layer, and lower than or equal to the complete melting temperature point (T4) of the high melting range component of the liquid-proof film. The heat-stitching time may range from 0.01 to 600 seconds, preferably 0.01 to 480 seconds, more preferably 0.1 to 300 seconds, especially preferably 1 to 60 seconds, further preferably 1 to 30 seconds. Preferably, the heat-sealing pressure ranges from 0.01 MPa to 1 MPa, more preferably 0.1 MPa to 0.8 MPa, most preferably 0.1 MPa to 0.6 MPa.

In the stitching method of the liquid-proof stitched fabric (laminate), the heat pressing equipment used may be an ultrasonic sealing machine, a radiofrequency sealing machine, a pulse sealing machine, a roller sealing machine, etc.

### EMBODIMENTS OF THE INVENTION

Hereinafter, the present invention will be better described with the following representative examples. It is understood that the following examples are only used to explain this invention and do not limit the scope of this invention, and any non-essential improvements and modifications made by a person skilled in the art based on this invention all fall into the protection scope of this invention. The specific parameters below are only exemplary, and a person skilled in the art can choose proper values within an appropriate range according to the description of this article, and are not restricted to the specific values cited below.

In the following embodiments, the methods for testing peeling force, hydrostatic pressure, blood barrier property, and virus barrier property are as follows:

(1) Test standard of peeling force:

A) Test standard: GB 88080;

B) Sampling standard: samples are taken at every distance of about 150 mm from a location 15 mm far from one edge in the width direction, and at every distance of 500 mm in the length direction. The size of the test sample is 15×180 mm, and the number of samples taken in the direction of width and length totals fifty.

(2) Test standard of hydrostatic pressure:

A) Test standard: AATCC127;

B) Sampling standard: at least three pieces of samples of 200 mm×200 mm are taken in the diagonal direction, test areas should be prevented from folding and contamination. The samples are humidified for at least 4 hours at a temperature of (21±2) ° C. and a humidity of (65±2)% before testing, and the obverse and reverse sides of the fabric need to be distinguished during testing.

C) Test method: at a temperature of (21±2) ° C., the water on the surface of the clamping device is wiped, and the sample humidified is clamped in such a manner that the obverse side of the sample contacts with the water surface. A test procedure and a boost rate (60 mbar/min) are selected, and the water pressure value is recorded when the third droplet appears. Three droplets should be in different positions and not within 3 mm from the clamp edge.

(3) Test standard of blood barrier property:

A) Test standard: ASTM F 1670;

B) Sampling standard:

1. Three samples are randomly selected for every material on composition, location (heterogeneous material design) or other conditions;

2. If the material has a sealing layer sandwiched between two fiber layers, the capillary effect of the material edge will lead to false positive test results, resulting in unacceptable results. Therefore, the edges of the test sample should be sealed to avoid the capillary effect. Before testing, the samples should be sealed with adhesives, sealant, solid paraffin, or foam with sticky agents;

3. Only the sample edge is sealed, leaving a central open area of 57 mm for testing.

4. If the sample needs to be sterilized when it is made into a finished product, the sample should be disinfected. The disinfection process should not affect the performance of the sample, and must meet the manufacturer's requirement.

5. Before test, the sample should be treated for at least 24 hours at a temperature of (21±5) ° C. and a relative humidity of 30-80%. 6. If allowed, other pretreatment conditions (such as sterilization) can be used to evaluate performance.

C) Test method: Samples are subjected to penetration tests of simulated body fluid (synthetic blood) at a specified pressure for specified time (first, kept at 0 kPa for 5 minutes, then kept at 13.8 kPa for 1 minute, and then kept at 0 kPa for 54 minutes). The occurrence of penetration is judged by naked eye observation. If there is any evidence indicating penetration of synthetic blood, the result is failure. The result report is pass or fail.

(4) Test standard of virus barrier property:

A) Test standard: ASTM F 1671;

B) Sampling standard:

1. Three samples are randomly selected for every material on composition, location (heterogeneous material design), or other conditions;

2. If the material has a sealing layer sandwiched between two fiber layers, the capillary effect of the material edge will lead to false positive test results, resulting in unacceptable results. Therefore, the edges of the test sample should be sealed to avoid capillary effect. Before testing, the samples should be sealed with adhesives, sealant, solid paraffin or foam with sticky agents;

3. Only the sample edge is sealed, leaving a central open area of 57 mm for testing.

4. If the sample needs to be sterilized when it is made into a finished product, the sample should be disinfected. The disinfection process should not affect the performance of the sample, and must meet the manufacturer's requirement.

5. Before test, the sample should be treated for at least 24 hours at a temperature of (21±5) ° C. and a relative humidity of 30-80%. 6. If allowed, other pretreatment conditions (such as sterilization) can be used to evaluate performance.

C) Test method: Samples are subjected to penetrating tests of bacteriophage liquid Phi-X174 at a specified pressure for specified time (first, kept at 0 kPa for 5 minutes, then kept at 13.8 kPa for 1 minute, and then kept at 0 kPa for 54 minutes). When no liquid penetration occurs, an analytical procedure is used to determine whether the virus has passed through the sample to the other side. If there is any evidence indicating penetration of liquid or virus, the result is failure. The result report is pass or fail.

(5) Test standard of barrier of penetrative alcohol or isopropanol penetrative liquid

A) Test standard: Self-made penetrative liquid

B) Sampling standard: three samples are randomly selected for every material.

C) The penetrative liquid is brushed on the seam, and, if there is seepage after 60 minutes, the result is a failure, and if there is no seepage, the result is pass.

(6) Test standard of crack of the seam:

A) Test standard: a steel ball is used to test cracking of the seam by rolling back and forth twice. The steel ball is a metal ball with an external diameter of 8.2 cm and an internal hole diameter of 2.2 cm.

B) Sampling standard: samples are taken at every distance of about 150 mm from a location 15 mm far from one edge in the width direction, and at every distance of 500 mm in the length direction. The size of the test sample is 15×180 mm, and the number of samples taken in the direction of width and length totals fifty.

### Example 1

A polyester derivative liquid-proof film layer which has a size of 1.6 m (width)×1000 m (length)×10 μm, and comprises a first high melting range component with a start melting temperature T1 of 170° C. and a complete melting temperature of 200° C., and a polyolefin non-woven fabric which has a grammage of 23 g/m² and has a maximum start melting temperature T3 of 140° C. were dot gravure bonded with a reactive solvent-free glue. The grammage of the glue is 2 g/m², and the production line speed is 80 m/min. Then the bonded product was subjected to cooling, rolling up, and glue curing, to give a two-layer fabric with smooth surface and no tacky tactility. Such fabrics were overlapped so that the liquid-proof film layers thereof face each other, as shown by the reference number “1” in FIG. 2, then heat sealed at 200° C. and 0.4 MPa pressure for 3 seconds by a heat sealing machine. The seam is smooth after a crack resistance test, as shown in FIG. 4. The peeling force is 30 N/5 mm. The test result of hydrostatic pressure is 120 mbar. The blood barrier ASTM F 1670 test is passed. The virus barrier ASTM F 1671 test is passed. There is no penetration of the penetrative liquid within 60 minutes. It can be confirmed from the example that the heat sealing at the temperature makes the films be softened and fused, and a liquid barrier effect is achieved.

### Example 2

The liquid-proof film layer of the example 1 were bonded with two polyolefin non-woven fabrics which have a grammage of 25 g/m² and have a maximum start melting temperature T3 of 140° C. The grammage of the glue is 3 g/m², and the production line speed is 100 m/min, then the bonded product was subjected to cooling, rolling up, and glue curing, to give a three-layer fabric with smooth surface and no tacky tactility. Such fabrics were overlapped so that any non-woven fabric layers thereof face to each other, as shown by the reference number “1” in FIG. 2, and heat sealing was carried out at 200° C., and the other conditions are the same as those in example 1. The seam after crack resistance test is as smooth as that of example 1. The peeling force is 28 N/15 mm. The test result of hydrostatic pressure is 130 mbar. The blood barrier ASTM F 1670 test is passed. The virus barrier ASTM F 1671 test is passed. It can be confirmed from this example that the temperature makes the three pieces of fabrics and intermediate material be fused, and a liquid barrier effect is achieved, without being affected by one more piece of non-woven fabric.

### Example 3

One layer of non-woven fabric of example 2 is replaced by a pure polyester non-woven fabric which has a grammage of 30 gsm and has a maximum start melting temperature of 220° C., while the other layer of non-woven fabric is still a PP non-woven fabric which has a grammage of 23 gsm and has a maximum start melting temperature of 140° C. The other processes are the same as example 2. Such fabrics were overlapped so that the non-woven fabric layers thereof face each other, and heat sealed at 260° C. on a heat sealing machine, while the other parameters are the same as example 1.

### Example 4

One layer of non-woven fabric of example 2 is replaced by a pure polyester non-woven fabric which has a grammage of 30 gsm and has a maximum start melting temperature of 220° C., while the other layer of non-woven fabric is still a PP non-woven fabric which has a grammage of 23 gsm and has a maximum start melting temperature of 140° C. The other processes are the same as example 2. Such fabrics were overlapped so that the PP non-woven fabric layers thereof face to each other, and heat sealed at 165° C. on a heat sealing machine, while the other parameters are the same as example 1.

### Example 5

One layer of non-woven fabric of example 2 is replaced by a pure polyester non-woven fabric which has a grammage of 30 gsm and has a maximum start melting temperature of 220° C., while the other layer of non-woven fabric is still a PP non-woven fabric which has a grammage of 23 gsm and has a maximum start melting temperature of 140° C. The other processes are the same as example 2. Such fabrics were overlapped so that a PP non-woven fabric layer faces to a polyester non-woven fabric layer, and heat sealed at 260° C. on a heat sealing machine, while the other parameters are the same as example 1.

After a crack resistance test, the seam of example 4 is as smooth as that of example 1, while the seam of example 3 has some cracks, as shown in FIG. 5. The peeling fastness at the seams of the liquid-proof fabrics in examples 3-5 are 35 N/15 mm, 30 N/15 mm, and 1 N/15 mm, respectively, and example 5 shows that the PP non-woven fabric surface is separated from the PET non-woven fabric surface. The test results of hydrostatic pressure at the seams of the liquid-proof fabrics in examples 3-5 are 190 mbar, 140 mbar, and 5 mbar, respectively. the example in which PP non-woven fabric layers face each other when overlapping passes the virus barrier ASTM F 1671 test and the blood barrier ASTM F 1670 test, while the others fail. It can be confirmed from examples 3-5 that: if the non-woven fabrics of different materials with different melting points are heat stitched, it needs to ensure that the stitching surfaces are fused with each other, otherwise, the peeling strength and barrier property of the heat-sealed surface will be affected. and that if the maximum start melting temperature of non-woven fabrics is too higher than the melting temperature of liquid-proof materials, the liquid-proof film layer will be fused and cracked.

### Examples 6-9

The films of example 2 were replaced by films with the same melting point and with a thickness of 10 μm, 12 μm, 20 μm, and 30 μm, respectively, and the grammages of the glues are adjusted to 3 gsm, 3 gsm, 5 gsm, and 6 gsm, respectively, to obtain three-layer fabrics with smooth surfaces. Such fabrics were overlapped so that non-woven fabric layers face each other, and heat sealed at 200° C. on a heat sealing machine, while the other parameters are the same as example 1. The seams of examples 6-9 after crack resistance test are as smooth as that of example 1. The peeling forces are 32 N/15 mm, 32.5 N/15 mm, 35 N/15 mm, and 38 N/15 mm, respectively. The test results of hydrostatic pressure are 140 mba, 145 mba, 165 mba, 190 mbar, respectively. All the products passed the blood barrier ASTM F 1670 tests, the virus barrier ASTM F 1671 tests, and the penetrative liquid barrier test. It can be confirmed from examples 6-9 that the increase of film thickness has no impact on the barrier property of the seal of the fabric, and contributes greatly to the peeling fastness and hydrostatic pressure.

### Examples 10-13

The three-layer fabrics of example 2 were overlapped so that non-woven fabric layers face each other, as shown by reference number “1” in FIG. 2, and heat sealed at 120° C., 140° C., 190° C., and 200° C., respectively, on a heat sealing machine. The crack resistance tests of the seams show that: layer separation occurs in example 10, cracks appear in example 11 (as shown in FIG. 6), and the seams of examples 12 and 13 are as smooth as that of example 1. The peeling forces are 3 N/I5 mm, 23 N/15 mm, 30 N/15 mm, and 35 N/15 mm, respectively. The test results of hydrostatic pressure are 14 mbar, 120 mbar, 135 mbar, and 50 mbar, respectively. Only examples 11 and 12 pass the blood barrier ASTM F 1670 test, virus barrier ASTM F 1671 test, and penetrative liquid barrier test. It can be confirmed from examples 10-13 that a too high heat-sealing temperature leads to fusing and cracking of the liquid-proof film, a too low heat-sealing temperature leads to an ineffective heat seal, and a heat-sealing temperature too close to the lowest start melting temperature of the material leads to crackles in the seam.

1. A liquid-proof stitched fabric, characterized in that the liquid-proof stitched fabric comprises a plurality of liquid-proof fabric layer units stitched by means of a heat-sealing method, and each of the liquid-proof fabric layer units comprises:
at least one liquid-proof film layer, the liquid-proof film layer comprising at least a first high melting range component and a second low melting range component, wherein a first start melting temperature of the first high melting range component is higher than a second start melting temperature of the second low melting range component by 10° C. or more;
at least one thermoplastic non-woven fiber layer, a maximum start melting temperature of the thermoplastic non-woven fiber layer being lower than the first start melting temperature; and
a discontinuous bonding layer located between the at least one liquid-proof film layer and the at least one thermoplastic non-woven fiber layer;
wherein a heat-sealing temperature of the heat-sealing method is lower than or equal to a complete melting temperature of the liquid-proof film layer, but higher than the maximum start melting temperature of the thermoplastic non-woven fiber layer.

2. The liquid-proof stitched fabric according to claim 1, characterized in that the thickness of the liquid-proof film layer is 3 to 200 μm.

3. The liquid-proof stitched fabric according to claim 1, characterized in that the first start melting temperature is higher than the second start melting temperature by 15° C. or more.

4. The liquid-proof stitched fabric according to claim 1, characterized in that the grammage of the thermoplastic non-woven fiber layer is 1 to 500 gsm.

5. The liquid-proof stitched fabric according to claim 1, characterized in that the grammage of the discontinuous bonding layer is 0.8 to 50 g/m².

6. The liquid-proof stitched fabric according to claim 1, characterized in that at least one of the first high melting range component and the second low melting range component is at least one selected from polyolefin and its derivatives, polyvinyl acetate and its derivatives, polyvinyl chloride and its derivatives, polyvinyl alcohol and its derivatives, polyethylene terephthalate and its derivatives, polyamide and its derivatives, and polybutylene terephthalate and its derivatives.

7. The liquid-proof stitched fabric according to claim 1, characterized in that the thermoplastic non-woven fiber layer comprises at least one of: fiber of polyester and its derivatives, fiber of polyamide and its derivatives, fiber of polyolefin and its derivatives, bio-based fiber, and degradable fiber.

8. A stitching method of a liquid-proof stitched fabric according to claim 1, characterized in that the stitching method comprises:
dot gluing at least one liquid-proof film layer and at least one thermoplastic non-woven fiber layer with a glue, followed by cooling, rolling up, and glue curing, to form a liquid-proof fabric layer unit;
overlapping two adjacent liquid-proof fabric layer units, and heat sealing them at a heat-stitching temperature lower than or equal to the complete melting temperature of the liquid-proof film layer, but higher than the maximum start melting temperature of the thermoplastic non-woven fiber layer, to stitch the two adjacent liquid-proof fabric layer units together, wherein the heat sealing is conducted at a pressure of 0.01 to 1 MPa for 0.01 to 600 seconds.

9. The stitching method according to claim 8, characterized in that the two adjacent liquid-proof fabric layer units are overlapped in such a manner that layers of the same material face each other.

10. The stitching method according to claim 8, characterized in that the heat-sealing temperature is lower than or equal to the first start melting temperature, but higher than the maximum start melting temperature of the thermoplastic non-woven fiber layer.

11. The liquid-proof stitched fabric according to claim 2, characterized in that the thickness of the liquid-proof film layer is 5 to 100 μm.

12. The liquid-proof stitched fabric according to claim 11, characterized in that the thickness of the liquid-proof film layer is 5 to 50 μm.

13. The liquid-proof stitched fabric according to claim 3, characterized in that the first start melting temperature is higher than the second start melting temperature by 18° C. or more.

14. The liquid-proof stitched fabric according to claim 4, characterized in that the grammage of the thermoplastic non-woven fiber layer is 5 gsm to 200 gsm.

15. The liquid-proof stitched fabric according to claim 14, characterized in that the grammage of the thermoplastic non-woven fiber layer is 20 gsm to 50 gsm.

16. The liquid-proof stitched fabric according to claim 5, characterized in that the grammage of the discontinuous bonding layer is 0.8 to 16 g/m².

17. The liquid-proof stitched fabric according to claim 16, characterized in that the grammage of the discontinuous bonding layer is 1 to 16 g/m².

18. The stitching method according to claim 8, characterized in that the heat sealing is conducted at a pressure of 0 0.1 to 0.8 MPa, for 1 to 60 seconds.
